(19) United States
(12) Patent Application Publication
(10) Pub. No.: US 2025/0378269 A1
(43) Pub. Date: Dec. 11, 2025

(54) CONTRACT MANAGMENT SYSTEM AND CONTRACT MANAGEMENT METHOD

(71) Applicant: Hitachi, Ltd., Tokyo (JP)

(72) Inventors: Yusuke ARAI, Tokyo (JP); Tatsuya SATO, Tokyo (JP); Takahiro SAGARA, Tokyo (JP)

(73) Assignee: Hitachi, Ltd., Tokyo (JP)

(21) Appl. No.: 19/065,271

(22) Filed: Feb. 27, 2025

(30) Foreign Application Priority Data
Jun. 5, 2024 (JP) 2024-091610

(51) Int. Cl. G06F 40/20

(52) U.S. Cl. CPC G06F 40/20

(57) ABSTRACT

A contract management system acquires application information, which is information obtained from an applicant applying for the execution of a contract, written in natural language, and extracts contract event information, which is information related to a contract event, which is an event that causes the execution of the contract, from the contract written in natural language. The contract management system inputs the application information and the contract event information extracted from the contract into a large language model to determine whether the application information includes a contract event. If the application information includes a contract event, the contract management system acquires contract execution information, which is information necessary for the execution of the contract corresponding to the contract event, by inputting the application information into the large language model, and inputs the acquired contract execution information into the contract execution system.

### BACKGROUND

### Technical Field

The present invention relates to a contract management system and a contract management method.

### Background Art

Patent Document 1 describes a system configured to have as its object the implementation of P2P insurance using a smart contract based on blockchain technology. The system receives a user application to join an insurance group, stores information that identifies the user as a participant of the insurance group based on the received participation application, and determines whether the insurance group has been established. If it determines that the insurance group has been established, the system generates a transaction for generating a smart contract for implementing P2P insurance in the insurance group and transmits the transaction to at least one computer that functions as a blockchain node. The smart contract includes information that identifies each user stored as a participant of the insurance group.

### LIST OF CITATIONS

### Patent Documents

Patent Document 1: JP 2020-91515

### SUMMARY OF INVENTION

### Problem to be Solved by the Invention

In the insurance business using decentralized finance (DeFi), automatic execution of contracts using smart contracts that require consensus building among multiple nodes is one of the important use cases.

However, contracts written in natural language must be written in a specialized language such as Solidity (registered trademark), which makes designing and developing smart contracts time-consuming and inefficient.

The above-described Patent Document 1 does not describe any technology that implements a mechanism for automatically executing contracts based on contracts written in natural language.

The present invention aims to provide a contract management system and a contract management method that can efficiently execute contracts based on contract documents written in natural language.

### Solving the Problem

One aspect of the present invention for achieving the above object is a contract execution support system configured using an information processing device having a processor and a storage device, that can access a large language model, which is a model that generates and outputs information written in natural language according to a prompt written in natural language when given as input, and can communicate with a contract execution system that performs processing related to the execution of a contract; stores contract data written in natural language; acquires application information, which is data written in natural language that is information acquired from an applicant regarding the execution of a contract; extracts, from the contract, contract event information, which is information related to a contract event that is an event that causes the execution of a contract; inputs the application information and the contract event information extracted from the contract into the large language model; determines whether the application information includes the contract event, and if the application information includes the contract event, inputs the application information into the large language model to acquire contract execution information, which is information necessary for the execution of a contract corresponding to the contract event, and inputs the acquired contract execution information into the contract execution system.

Other problems and solutions disclosed in this application will be clarified by the description of the preferred embodiment and the drawings.

### Advantageous Effects of the Invention

According to the present invention, it is possible to efficiently execute a contract based on a contract written in natural language.

### BRIEF DESCRIPTION OF DRAWINGS

FIG. 1 is a diagram illustrating a schematic configuration of a contract management system.

FIG. 2 is a schematic diagram explaining a process flow when executing a contract using a contract execution support system.

FIG. 3A is a diagram illustrating main functions of a contract execution support device.

FIG. 3B is a diagram illustrating main functions of a contract execution device.

FIG. 4 is a diagram illustrating an example of a contract and contract event information extracted from the contract.

FIG. 5 is a diagram illustrating an example of a prompt for extracting contract event information from a contract.

FIG. 6 is a flowchart explaining contract execution processing.

FIG. 7 is a diagram illustrating an example of an information processing device used to implement a contract management system.

### DETAILED DESCRIPTION OF EMBODIMENTS

An embodiment of the present invention are described below with reference to the accompanying drawings.

In the following description, the same or similar parts may be designated by the same reference numerals and redundant description omitted. In the following description, the letter “S” before a reference numeral indicates a step in a process.

In the following description, “contract” means a document that certifies that a contract has been concluded (established, renewed, changed, supplemented, etc.) between the parties to the contract. Below, for convenience, an insurance contract is used as an example.

In the following description, “policyholder information” refers to information about a policyholder.

In the following description, “contract execution” refers to the fulfillment of the terms of the contract. In the case of an insurance contract, contract execution refers to, for example, actually paying the insurance premium or insurance benefit and causing the transfer of money (including virtual currency; the same applies below).

In the following description, a “contract event” is an event that triggers or may trigger the execution of a contract, such as the payment of insurance premiums or insurance benefits, or the deposit of monthly insurance premiums.

In the following description, “premium” refers to the money paid by the policyholder to the insurance company as consideration for coverage under an insurance contract.

In the following description, “insurance benefits” refers to money paid by an insurance company to an insured person when a contractual event occurs that triggers the execution of an insurance contract.

In the following description, “contract event arguments” refers to information extracted from the contract, and is the specified information required for the execution of the contract (evidence information, identity verification information, certificate of fact, etc.). If the contract is an insurance contract, the contract event arguments are, for example, a physician's death certificate, a physician's disability certificate, hospitalization records, the amount of insurance premium or insurance payment to a bank account, the name of the transferee, etc.

In the following description, “contract execution information” refers to information used in the execution contract (including policyholder information and of a contract event arguments).

In the following description, “AI” (Artificial Intelligence) refers to artificial intelligence implemented using an information processing device.

In the following description, “generative AI” (Generative Artificial Intelligence) refers to AI that is capable of generating various types of content. In the present embodiment, generative AI is used primarily for reading natural language and making decisions.

In the following description, it is assumed that various information written in natural language is managed and stored (recorded) as electronic data in a format capable of being expressed in natural language, such as text format.

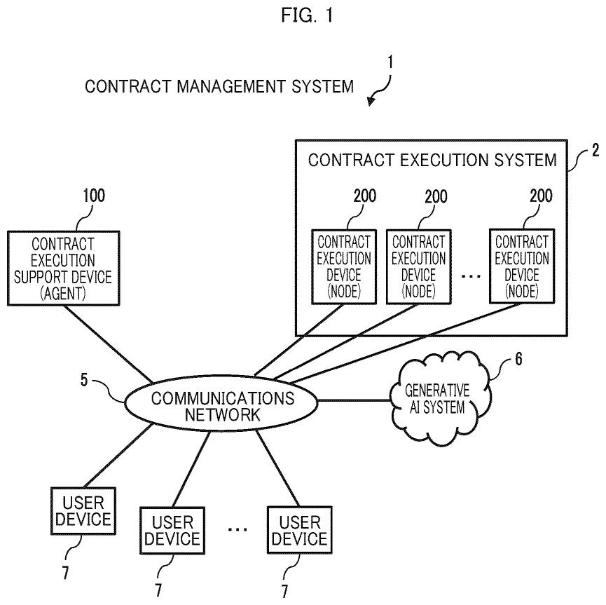

FIG. 1 illustrates a schematic configuration of an information processing system (hereinafter, referred to as a “contract management 1”) system according to an embodiment of the present invention. As shown in the drawing, the contract management system 1 includes a contract execution support device 100, a contract execution system 2, a generative AI system 6, and one or more user devices 7.

The contract execution support device 100, the contract execution system 2, the generative AI system 6, and the user device 7 are all configured using information processing devices (computers), and are connected to each other in a state capable of two-way communication via a communication network 5. The communication network 5 is wireless or wired communication infrastructure, such as the Internet, a LAN (Local Area Network), a WAN (Wide Area Network), various public communication networks, a dedicated line, etc.

The contract execution system 2 is an information processing system that performs processes related to the execution of insurance contracts (such as settlements between bank accounts and transfers of virtual currency (tokens)). The contract execution system 2 is used for various operations at insurance companies, such as insurance applications and contracts, collection of insurance premiums, payment of insurance benefits, and management of contract information.

As shown in the drawing, the contract execution system 2 includes a plurality of contract execution devices 200 that form a consensus. The contract execution system 2 is an information processing system implemented as a Web 3.0 system (distributed ledger system) using blockchain technology (distributed ledger technology) in which the contract execution device 200 is implemented as a distributed processing node (a node of a P2P (Peer-to-Peer) network). The contract execution system 2 executes a contract (insurance contract) by issuing an execution instruction (hereinafter referred to as a “contract execution request”) to the contract execution device 200. When the contract execution system 2 is implemented as a Web 3.0 system, the contract execution request is a transaction that activates a smart contract (serves as a trigger for activating the smart contract). The contract execution support device 100 is installed, for example, in a branch or unit of an organization such as an insurance company.

The contract execution support device 100 is one or more information processing devices that support human work related to the execution of a contract carried out using the contract execution system 2.

The generative AI system 6 stores large language models (LLMs), which are pre-trained models trained by machine learning using large amounts of natural language data. When a prompt written in a natural language is input, the large language model outputs information (sentences, program codes, etc.) written in a natural language generated according to the prompt. Examples of large language models include “ChatGPT (registered trademark)”, “Code Interpreter”, and “Open Interpreter”. Note that, in this embodiment, the contract execution support device 100 and the contract execution system 2 use the large language model provided by generative AI system the 6. Alternatively, each of the contract execution support device 100 and the contract execution system 2 (or the contract execution devices 200 constituting the contract execution system 2) may have an environment for using the large language model individually.

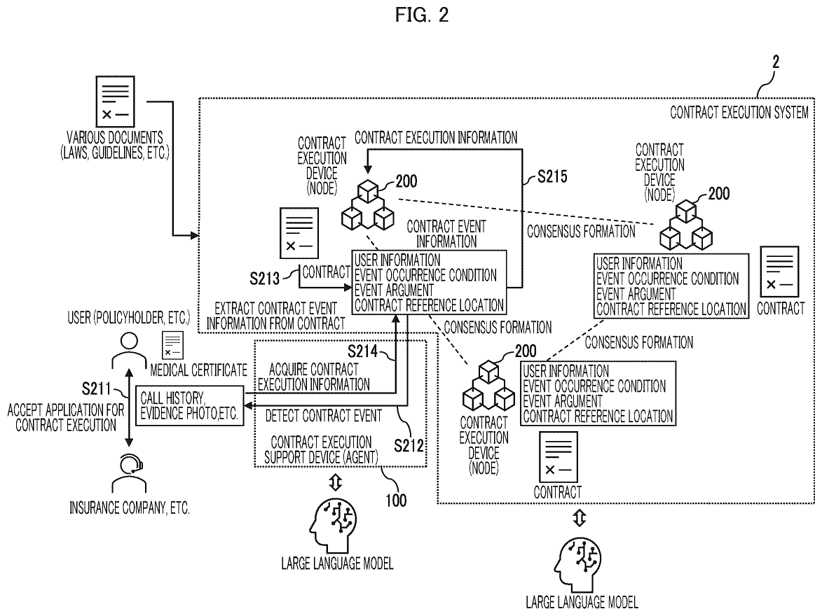

FIG. 2 is a schematic diagram explaining processing flow when executing a contract using the contract management system 1. The following description is given with reference to this drawing.

The contract execution support device 100 receives an application (request) for contract execution from a person (such as an insured person, hereinafter referred to as the “applicant”) who applies for contract execution (S211). For example, a dialogue (by telephone, online chat, etc.) is conducted between the applicant and an operator of the insurance company, and information describing a call history, online chat history, etc., in natural language (information converted by voice recognition technology in the case of a call history) (hereinafter referred to as “application information”) is input into the contract execution support device 100. The application information includes, for example, information regarding the contract event (the date and time of the contract event, the location where the contract event occurred, the details of the incident (accident, incident, etc.) that caused the contract event) and information identifying the insurance company, the policyholder and the insured.

Next, the contract execution support device 100 determines whether the application information includes information that generates a contract event based on the received application information and the terms of the insurance contract (S212). The contract execution support device 100 makes the above determination, by, for example, comparing the application information with information concerning the contract event (hereinafter referred to as “contract event information”) extracted from the contract (S213). In addition, the contract execution support device 100 makes the above determination by, for example, inputting into a large language model the application information, the contract event information, and a prompt indicating that the above determination is to be made.

If it is determined that the application information includes information that will cause a contract event, the contract execution support device 100 acquires contract execution information the from input application information (S214). Note that, if the information provided by the applicant is insufficient or valid contract execution information cannot be acquired from the application information, the contract execution support device 100 notifies the applicant of this fact via the user device 7, for example, or requests additional application information.

Next, the contract execution system 2 decides whether or not to execute the applied contract based on the contract execution information and the contract acquired by the contract execution support device 100 (S215). Note that the contract execution system 2 may also make the above decision based on, for example, dialogue processing with a person who performs work related to the execution of the contract (such as a person in charge at an insurance company). In that case, the contract execution system 2 makes the above decision by, for example, inputting the contract execution information, the contract, and a prompt describing the above decision into a large language model. Furthermore, the contract execution system 2 makes the above decision while, for example, forming a consensus among the contract execution devices 200 constituting the contract execution system 2, for the purpose of improving the reliability of contract execution and preventing fraud. If it is decided to execute the contract, the contract execution system 2 executes the contract.

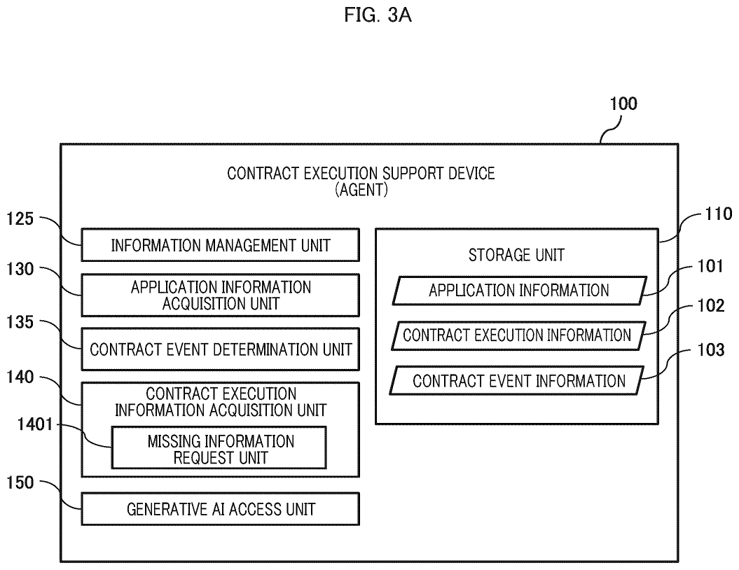

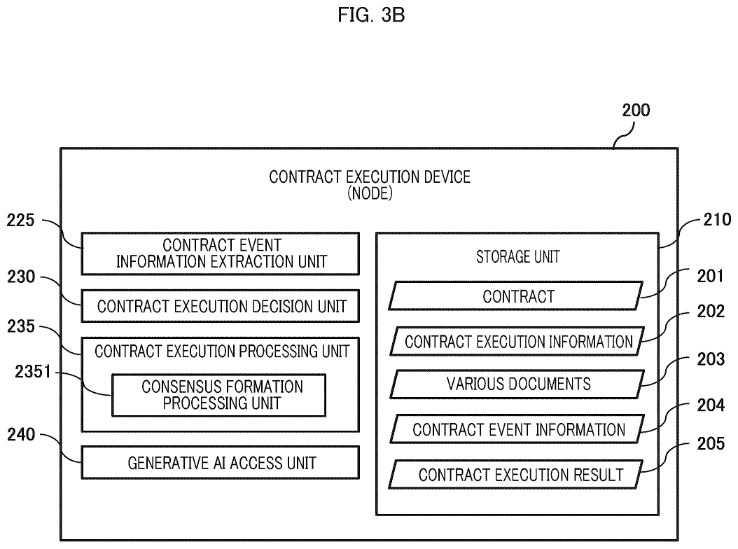

FIG. 3A illustrates the main functions of the contract execution support device 100. As shown in the drawing, the contract execution support device 100 has the functions of a storage unit 110, an information management unit 125, an application information acquisition unit 130, a contract event determination unit 135, a contract execution information acquisition unit 140, and a generative AI access unit 150.

Of the above functions, the storage unit 110 stores the application information 101, the contract execution information 102, and the contract event information 103.

The application information 101 is the above-described application information acquired from the applicant by the application information acquisition unit 130. The application information 101 includes, for example, a history of a dialogue with the applicant via the user device 7 (call history, online chat history, etc.), and various information acquired from the applicant (insurance benefit form, accident information explanation, evidence photo (photograph showing the damage, etc.), damage certificate, disaster victim certificate, construction estimate, certified copy of building registration, etc.).

The contract execution information 102 is the above-described contract execution information acquired by the contract execution information acquisition unit 140 from the application information 101. The contract execution information 102 includes, for example, information identifying the insured, information identifying the insured's account, information identifying the insurance company's account, the amount of the insurance premium, the amount of the insurance payout, the timing of execution of the contract, etc.

The contract event information 103 is contract event information sent from the contract execution device 200.

Among the functions shown in the drawing, the information management unit 125 acquires various information used for contract execution, such as the contract 201, various documents 203, and contract event information 103 sent from the contract execution device 200, via a user interface or communication, and manages the acquired information in the storage unit 110. In addition, the information management unit 125 shares the above various information between the contract execution support device 100 and each of the contract execution devices 200 that constitute the contract execution system 2.

The application information acquisition unit 130 acquires the application information 101 via the user device 7 and manages the acquired information as the application information 101 in the storage unit 110.

The contract event determination unit 135 makes the above determination by, for example, inputting the application information 101, the contract event information 204, and a prompt indicating that the above determination is to be made into the large language model. For example, the contract event determination section 135 makes the above determination based on the information output by the large language model by inputting into the large language model as a prompt content indicating that a contract event is to be detected by comparing the application information 101 with the contract event information 204.

Note that, in this way, the contract event determination unit 135 determines whether or not the description in the application information 101 contains information that causes a contract event based on the application information 101 and the contract event information 204, thereby making it possible to reduce the processing load compared to a case in which the application information is compared with the contract itself (full text). Moreover, output results can be obtained without reaching the upper limit on the number of input tokens that the large-scale language model has.

The contract execution information acquisition unit 140 acquires contract execution information from the application information 101 in which the contract event determination unit 135 has detected a contract event, and manages the acquired contract execution information as contract execution information 102. In addition, the contract execution information acquisition unit 140 transmits the acquired contract execution information to the contract execution device 200.

As shown in the same drawing, the contract execution information acquisition unit 140 includes a missing information unit request 1401. When the missing information request unit 1401 cannot acquire contract execution information from the application information 101, the missing information is acquired by, for example, prompting the user to additionally input the missing contract execution information via the user device 7. The contract execution information acquisition unit 140 acquires the contract execution information by, for example, inputting into the large language model as prompt content an instruction to acquire the contract execution information from the application information 101.

The generative AI access unit 150 provides an environment for using the large language model provided by the generative AI system 6 to each of the aforementioned functions of the contract execution support devices 100.

FIG. 3B illustrates the main functions of the contract execution device 200. As shown in the drawing, the contract execution device 200 has the functions of a storage unit 210, a contract event information extraction unit 225, a contract execution decision unit 230, a contract execution processing unit 235, and a generative AI access unit 240.

Of the above functions, the storage unit 210 stores the following information: A contract 201, contract execution information 202, various documents 203, contract event information 204 and contract execution result 205.

Of these, the contract 201 includes various information regarding the contract written in natural language (information regarding the contract, terms and conditions, notification obligations, information regarding the cooling-off system, and other information used in executing the contract).

The contract execution information 202 is contract execution information 102 received from the contract execution support device 100 (contract execution information 102 that the contract execution information acquisition unit 140 has acquired from the application information 101).

The various documents 203 comprise information written in natural language (laws, regulations, operational guidelines, etc.) that is referenced when a large language model or a person determines whether or not to execute a contract for a contract event detected by the contract event determination unit 135 of the contract execution support device 100.

The contract event information 204 is the above-described contract event information 204 extracted from the contract 201. The contract event information 204 includes information on the contract events described in the contract 201, organized and listed for each contract event.

The contract execution result 25 includes information indicating the result of execution of the contract (execution contents, execution completion notice, etc.) sent from the contract execution system 2. The contents of the contract execution result 25 are presented to, for example, related parties (insurance company personnel, applicant, policyholder, the insured, etc.).

The contract event information extraction unit 225 manages the extracted contract event information in the storage unit 210 as contract event information 204. In addition, the contract event information extraction unit 225 transmits the contract event information to the contract execution support device 100. Note that, when the contract execution support device 100 receives contract event information from the contract execution device 200, it manages the received contract event information in the storage unit 110 as contract event information 103. The contract event information extraction unit 225 extracts contract event information from the contract 201 by using, for example, a large language model. In addition, the contract event information extraction unit 225 extracts contract event information from the contract 201 by, for example, dialogue processing with a person performed via a user interface.

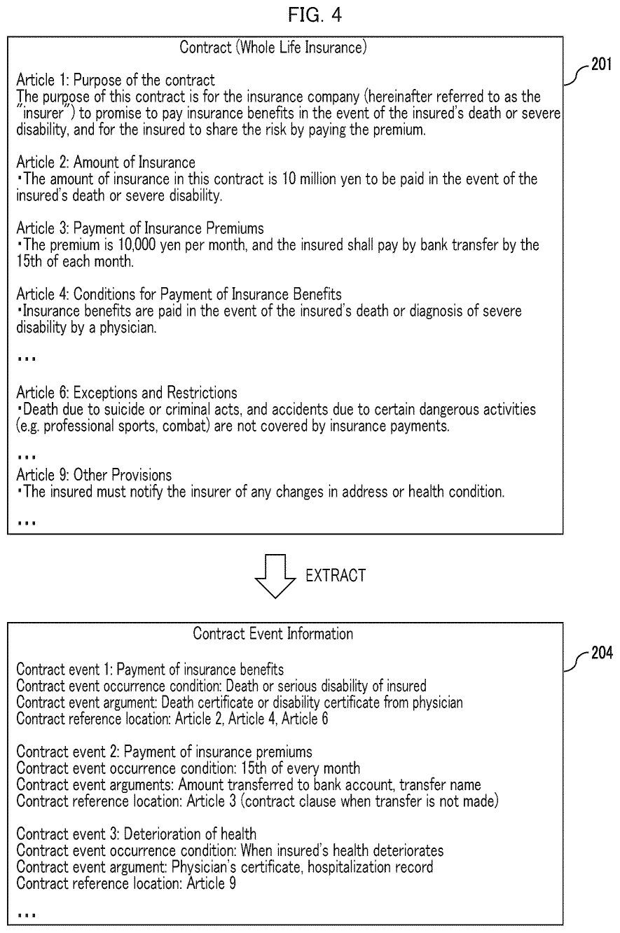

FIG. 4 shows an example of a contract 201 (insurance contract) and contract event information 204 extracted from the contract 201. In the example shown in the drawing, information on “contract event 1” is extracted from “Article 2,” “Article 4,” and “Article 6,” information on “contract event 2” is extracted from “Article 3,” and information on “contract event 3” is extracted from “Article 9.” In this example, the extracted information includes information indicating the contents of predetermined items (content of contract event, occurrence condition of contract event, contract event argument, and contract reference point) for each contract event. For example, in the case of “contract event 1,” which is one of the contract events, “payment of insurance benefits” is extracted as the content of the contract event, “at the time of death or serious disability of the insured” is extracted as the occurrence condition of the contract event, “death certificate from physician, disability certificate from physician” is extracted as the contract event argument of the contract event, and “Article 2, Article 4, Article 6” are extracted as the contract reference points.

Among the above items, the contract reference points are used for the purpose of making it easier to identify the portion of the contract related to the contract event when a person or a large language model determines whether or not the contract is to be executed.

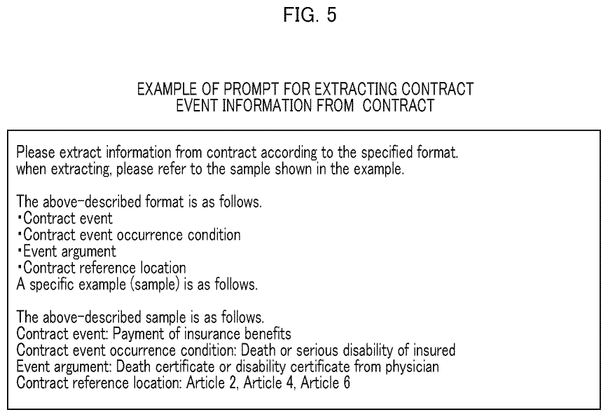

FIG. 5 illustrates an example of a prompt for extracting contract event information from a contract using a large language model. The prompt illustrated n the example includes the contents of the contract from which the information is extracted, a specification of the format of the contract event information, a sample of the extraction result, and an instruction to extract contract event information from the contract, etc.

Returning to FIG. 3B, the contract execution decision unit 230 decides whether or not to execute the contract for the contract event detected by the contract event determination unit 135 of the contract execution support device 100 based on information such as the contract execution information 202, the contract 201, and various documents 203, which are the contract execution information 102 received from the contract execution support device 100. The contract execution decision unit 230 makes the above decision by, for example, performing dialogue processing with the execution manager (such as an employee of an insurance company) while presenting the above information to the execution manager who decides whether or not to execute the contract via a user interface. In addition, the contract execution decision unit 230 makes the above decision by, for example, inputting into a large language model the contract execution information 102, the contract 201, the various documents 203, and a prompt with contents instructing that the above decision be made.

When the contract execution decision unit 230 decides to execute the contract of the contract event, the contract execution processing unit 235 executes the contract based on the contract execution information 202. As shown in the drawing, the contract execution processing unit 235 includes a consensus formation processing unit 2351. When consensus formation is required for the execution of a contract, the consensus formation processing unit 1271 forms consensus among the multiple contract execution devices 200 (hereinafter also referred to as “nodes”) that constitute the contract execution system 2. The consensus formation processing unit 2351 executes the contract when a consensus is reached among the nodes (for example, when a number of nodes exceeding a predetermined number agree to the execution of the contract).

The contract execution processing unit 235 may be implemented by using a large language model. In this case, for example, the large language model receives contract event arguments as input, and automatically executes processing related to contract execution based on the contract 201 using a code generation tool (such as “Code Interpreter”, “Open Interpreter” or the like).

However, it is possible that consensus will not be reached due to the non-deterministic nature of large language models (the property that the output when each node inputs a common prompt into the large language model is not necessarily uniquely determined). Therefore, if consensus is not reached (if consensus formation fails), each contract execution device 200 may receive the result of approval or disapproval of the contract execution from a user (a person having the authority to decide on the execution of the contract) via a user interface, and decide whether or not to execute the contract depending on the result of approval or disapproval from each user thus obtained.

The generative AI access unit 150 provides a usage environment for the large language model provided by the generative AI system 6 to each of the aforementioned functions of the contract execution device 200.

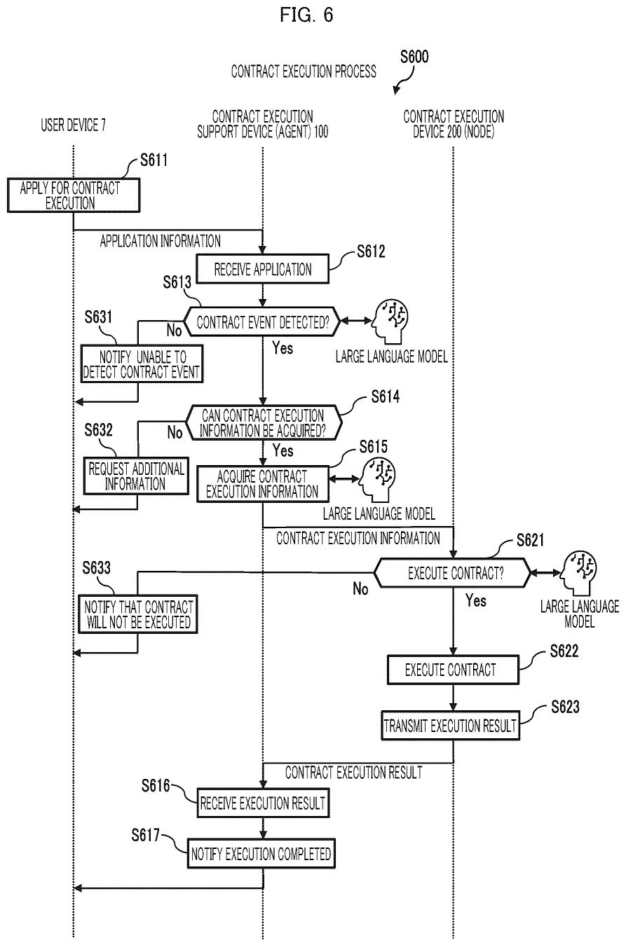

FIG. 6 is a system flow diagram (inter-device cooperation flow diagram) for explaining the process (hereinafter referred to as “contract execution process S600”) carried out in the contract management system 1. The contract execution process S600 is described below with reference to this diagram.

In the following description it is assumed that, when the contract execution process S600 is executed, the memory unit 110 of the contract execution device 200 stores the contract 201 in advance. Also, it is assumed that the storage unit 210 of the contract execution device 200 stores the various documents 203 in advance.

It is also assumed that the contract event information extraction unit 225 of the contract execution device 200 extracts contract event information in advance based on the contract 201 and manages it as contract event information 204 in the memory unit 110 (stores it in the storage unit 210, records it in the blockchain, etc.). It is also assumed that the contract event information 204 is shared as contract event information 103 in the contract execution support device 100. As described above, the generation of the contract event information 204 from the contract 201 may be performed using, for example, a large language model provided by the generative AI system 6.

As shown in the drawing, first, the application information acquisition unit 130 of the contract execution support device 100 accepts application information from a user via the user device 7, and manages the accepted application information as application information 101 (S611 to S612).

Next, the contract event determination unit 135 of the contract execution support device 100 determines whether or not the application information 101 contains information that generates a contract event (detects a contract event) based on the application information 101 and the contract 201 (or the contract event information 204) (S613). If the contract event determination unit 135 determines that the application information 101 contains information that generates a contract event (S613: Yes), the process proceeds to S614. On the other hand, if it determines that the application information 101 does not contain information that generates a contract event (S613: No), the contract event determination unit 135 notifies the user (policyholder, etc.), via the user device 7, for example, that a contract event cannot be detected (S631).

In S614, the contract execution information acquisition unit 140 of the contract execution support device 100 determines whether or not it is possible to acquire the contract execution information based on the application information 101 (S614). When the contract execution information acquisition unit 140 determines that it is possible to acquire the contract execution information acquired based on the application information 101 (S614: Yes), the process proceeds to S615. On the other hand, when the contract execution information acquisition unit 140 determines that the contract execution information cannot be acquired based on the application information 101 (S614: NO), the missing information request unit 1401 of the contract execution information acquisition unit 140 makes a request to the applicant to provide additional application information via, for example, the user device 7 (S632).

In S615, the contract execution information acquisition unit 140 acquires contract execution information based on the application information 101, and transmits the acquired contract execution information to the contract execution device 200. The contract execution device 200 manages the transmitted contract execution information in the storage unit 210 as contract execution information 202.

In S621, the contract execution decision unit 230 of the contract execution device 200 decides whether or not to execute the contract based on information such as the contract execution information 202, the contract 201, and the various documents 203. The contract execution decision unit 230 performs s this decision using, for example, dialogue processing with a person who performs work related to the execution of the contract or a large language model. If it is decided to execute the contract (S621: Yes), the process proceeds to S622. On the other hand, if it is decided to not execute the contract (S621: No), the contract execution device 200 notifies, the user (policyholder, etc.) via the user device 7, for example, that the contract will not be executed (S633).

In S622, the contract execution processing unit 235 of the contract execution device 200 executes the contract based on the contract execution information 202 and transmits the result (contract execution result) to the contract execution support device 100 (S623).

The contract execution support device 100, upon receiving the contract execution result, stores it as contract execution result 205 (S616) and notifies the user (the policyholder, etc.) via the user device 7 that contract execution has been completed (S617).

As described above in detail, the contract execution support device 100 of this embodiment inputs information based on the contract 201 written in natural language (contract event information 204) and the application information 101 into a large language model to determine whether the application information 101 includes a contract event, and if the application information 101 includes a contract event, inputs the application information 101 into the large language model to obtain contract execution information and input it to the contract execution system 2, thus making it possible to efficiently execute a contract based on the contract 201 written in natural language.

### Example of Information Processing Device

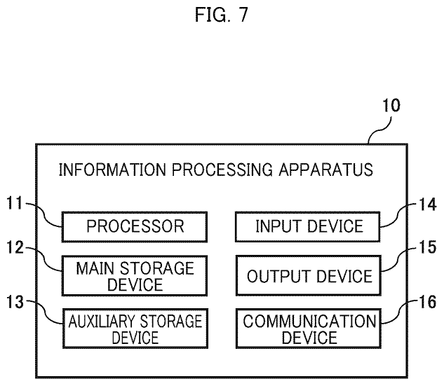

FIG. 7 illustrates an example of the hardware configuration of an information processing device (computer) used to implement the above-described contract management system 1. The contract execution support device 100 (agent) constituting the contract management system 1, the contract execution device 200 (node) constituting the contract execution system 2, the generative AI system 6, and the user device 7 are implemented, for example, using an information processing device having the configuration shown in the FIG. 7.

As shown in the drawing, the illustrated information processing device 10 includes a processor 11, a main storage device 12 (memory), an auxiliary storage device 13 (external storage device), an input device 14, an output device 15, and a communication device 16. These are communicatively connected via a bus, a communication cable, etc. Examples of the information processing device 10 include a personal computer, a server device, a smartphone, a tablet, an office computer, and a general-purpose machine (mainframe), etc.

The information processing device 10 may be implemented, in whole or in part, by using virtual information processing resources provided by using virtualization technology, process space separation technology, or the like, such as a virtual server provided by a cloud system. In addition, some or all of the functions provided by the information processing device 10 may be implemented by a service provided by a cloud system via an API (Application Programming Interface) or the like. In addition, some or all of the functions provided by the information processing device 10 may be implemented by using, for example, Software as a Service (Saas), Platform as a Service (PaaS), Infrastructure as a Service (IaaS), or the like.

The processor 11 is configured using, for example, a CPU (Central Processing Unit), an MPU (Micro Processing Unit), a GPU (Graphics Processing Unit), an FPGA (Field Programmable Gate Array), an ASIC (Application Specific Integrated Circuit), an AI (Artificial Intelligence) chip, etc.

The main memory device 12 is a device used by the processor 11 when executing a program, and is, for example, a ROM (Read Only Memory), a RAM (Random Access Memory), a non-volatile memory (NVRAM (Non Volatile RAM)), or the like. Various functions implemented in the contract management system 1 are implemented by the processor 11 of each information processing device 10 constituting the contract management system 1 reading out programs and data stored (memorized) in each auxiliary memory device 13 into the main memory device 12 and executing them.

The auxiliary storage device 13 is a device that stores programs and data, and can be configured, for example, as an SSD (Solid State Drive), a hard disk drive, an optical storage device (CD (Compact Disc), DVD (Digital Versatile Disc), etc.), a storage system, an IC card, a read/write device for non-transient recording media such as an SD card or an optical recording medium, a non-transient storage area of a cloud server, etc. Programs and data can be read into the auxiliary storage device 13 from other information processing devices equipped with non-transient recording media or non-transient storage devices via a recording medium reader or a communication device 16. The programs and data stored (stored) in the auxiliary storage device 13 are read into the main storage device 12 as needed.

The input device 14 is an interface that accepts input of information from the outside, and is, for example, a keyboard, a mouse, a touch panel, a card reader, a pen-input tablet, a voice input device, or the like.

The output device 15 is an interface that outputs various information such as the process progress and the process result to the outside. The output device 15 is, for example, a display device (liquid crystal monitor, LCD (Liquid Crystal Display), graphic card, etc.) that visualizes the above-described various information, a device that converts the above-described various information into voice (voice output device (a speaker, etc.)), and a device that converts the above-described various information into text (a printer, etc.). For example, the information processing device 10 may be configured to input and output information between the information processing device 10 and other devices via the communication device 16.

The input device 14 and the output device 15 constitute a user interface that implements interactive processing with the user (receiving information, providing information, etc.).

The communication device 16 is a device that implements communication with other devices. The communication device 16 is a wired or wireless communication interface that implements communication with other devices via the communication network 5, and is, for example, a network interface card (NIC), a wireless communication module, a USB module, or the like.

The information processing device 10 may be implemented by, for example, an operating system, a file system, a DBMS (DataBase Management System) (relational database, NoSQL, etc.), a KVS (Key-Value Store), or the like.

Although an embodiment has been described above, the present invention is not limited to the above-described embodiment, includes various modified examples, and is not necessarily to limited those having all of the configurations described. It is also possible to replace a part of the configuration of one embodiment with the configuration of another embodiment, or to add the configuration of another embodiment to the configuration of one embodiment. It is also possible to add, delete, or replace a part of the configuration of each embodiment with another configuration.

For example, if the contract execution system 2 is implemented using a Web 3.0 system (distributed ledger system), contract execution information (user (policyholder) information, conditions for contract event occurrence, contract event arguments, contract reference points, etc.) may be recorded in a blockchain in an unalterable state, and each of the contract execution devices 200 may be able to access the contract execution information recorded in the blockchain. Doing so allows the contract execution information to be shared safely among multiple contract execution devices 200, while improving the reliability of contract execution and preventing fraud.

Although in the preceding description the contract is an insurance contract, the contract is not limited to an insurance contract and the present invention is widely applicable to other types of contracts, such as rental contracts.

### LIST OF REFERENCE NUMERALS

1 Contract Management System
2 Contract Execution System
5 Communications Network
6 Generative AI System
7 User Device
100 Contract Execution Support Device
110 Storage Unit
101 Application Information
102 Contract Execution Information
103 Contract Event Information
125 Information Management Unit
130 Application Information Acquisition Unit
135 Contract event determination unit
140 Contract Execution Information Acquisition Unit
1401 Missing Information Request Unit
150 Generative AI Access Unit
200 Contract Execution Device
210 Storage Unit
201 Contract
202 Contract Execution Information
203 Various Documents
204 Contract Event Information
205 Contract Execution Result
225 Contract Event Information Extraction Unit
230 Contract Execution Decision Unit
235 Contract Execution Processing Unit
2351 Consensus Formation Processing Unit
240 Generative AI Access Unit
S600 Contract Execution Process

1. A contract management system configured using an information processing device including a processor and a storage device, that can access a large language model, which is a model that generates and outputs information written in natural language according to a prompt written in natural language when given as input, and can communicate with a contract execution system that performs processing related to execution of a contract,
the contract management system configured to:
store contract data written in natural language;
acquire application information, which is data written in natural language that is information acquired from an applicant regarding the execution of a contract;
extract, from the contract, contract event information, which is information related to a contract event that is an event that causes the execution of the contract;
input the application information and the contract event information extracted from the contract into the large language model; and
determine whether the application information includes the contract event, and if the application information includes the contract event, input the application information into the large language model to acquire contract execution information, which is information necessary for the execution of the contract corresponding to the contract event, and input the acquired contract execution information into the contract execution system.

2. The contract management system according to claim 1, wherein
the contract event information is information that lists information about the contract events described in the contract for each contract event.

3. The contract management system according to claim 1, wherein
the contract event information includes a type of the contract event, a contract event occurrence condition, which is a condition for the contract event occurrence, and a contract event argument, which is information necessary for executing the contract.

4. The contract management system according to claim 3, wherein
the contract event information further includes information identifying a reference location of the contract regarding the contract event.

5. The contract management system according to claim 1 including a contract execution system configured using a plurality of information processing devices communicably connected to each other, wherein
each of the plurality of information processing devices is a node of a distributed ledger system, and
the contract management system, while forming a consensus among the plurality of information processing devices, inputs the contract execution information into the contract execution system to perform processing related to the execution of the contract.

6. The contract management system according to claim 5, wherein
when consensus formation fails, each of the plurality of information processing devices accepts approval or disapproval of the execution of the contract from each user via a user interface, and determines whether or not to execute the contract based on the approval or disapproval of each of the users.

7. The contract management system according to claim 5, wherein
the contract management system records the contract execution information in the distributed ledger system, and
each of the plurality of information processing devices performs processing related to the execution of the contract by referring to the contract execution information recorded in the distributed ledger system.

8. The contract management system according to claim 5, wherein
each of the plurality of information processing devices is capable of executing a smart contract, and
the contract execution system performs processing related to the execution of the contract by issuing a transaction based on the contract execution information to the smart contract.

9. A contract management method executed by a contract management system that is configured using one or more information processing devices having a processor and a storage device, that is capable of accessing a large language model, which is a model that, when a prompt written in a natural language is given as an input, generates and outputs information written in a natural language in accordance with the prompt, and that is capable of communicating with a contract execution system that performs processing related to the execution of a contract,
the contract management method comprising:
storing data of a contract written in a natural language;
acquiring data describing information acquired from an applicant regarding execution of a contract in a natural language;
extracting contract event information from the contract, the contract event being information relating to a contract event, which is an event that causes execution of the contract;
determining whether the application information includes the contract event by inputting the application information and the contract event information extracted from the contract into the large language model; and
when the application information includes the contract event, inputting the application information into the large language model to obtain contract execution information, which is information necessary for executing a contract corresponding to the contract event, and inputting the obtained contract execution information into the contract execution system.

10. The contract management method according to claim 9, wherein
the contract event information is information that lists information about the contract events described in the contract for each contract event.

11. The contract management method according to claim 9, wherein
the contract event information includes a type of the contract event, a contract event occurrence condition, which is a condition for the contract event occurrence, and a contract event argument which is information necessary for executing the contract.

12. The contract management method according to claim 9, wherein
the contract execution system is configured using a plurality of information processing devices communicably connected to each other, and
each of the plurality of information processing devices is a node of a distributed ledger system,
the contract management method further comprising inputting the contract execution information into the contract execution system and performing processing related to the execution of the contract while forming a consensus among the plurality of information processing devices.

13. The contract management method according to claim 12, further comprising:
when the forming of the consensus fails, each of the plurality of information processing devices accepting approval or disapproval of the execution of the contract from each user via a user interface, and determining whether or not to execute the contract based on the approval or disapproval of each of the users.

14. The contract management method according to claim 12, further comprising:
recording the contract execution information in the distributed ledger system; and
each of the plurality of information processing devices performing processing related to the execution of the contract by referring to the contract execution information recorded in the distributed ledger system.

15. The contract management method according to claim 12, wherein
each of the plurality of information processing devices constitutes a node of a distributed ledger system capable of executing a smart contract, and
the contract execution system performs processing related to the execution of the contract by issuing a transaction based on the contract execution information to the smart contract.
